(19) United States
(12) Patent Application Publication
(10) Pub. No.: US 2013/0163114 A1
(43) Pub. Date: Jun. 27, 2013

(54) BASE ASSEMBLY FOR MOTOR AND HARD DISK DRIVE INCLUDING THE SAME

(71) Applicant: Il Geun JEON, Hwaseong (KR)

(72) Inventor: Il Geun JEON, Hwaseong (KR)

(73) Assignee: SAMSUNG ELECTRO-MECHANICS CO., LTD, Suwon (KR)

(21) Appl. No.: 13/408,052

(22) Filed: Feb. 29, 2012

(30) Foreign Application Priority Data
Dec. 22, 2011 (KR) 10-2011-0139994

(51) Int. Cl. G11B 21/02; H01F 7/00

(52) U.S. Cl. 360/75; 335/219; G9B/21.003

(57) ABSTRACT

There is provided a base assembly for a motor, including: a base for a motor; a magnet mounted in the base to provide a driving force to a magnetic head; and a magnet insertion part having the magnet inserted therein and formed to penetrate through the base so as to restrict a movement of the magnet.

### CROSS-REFERENCE TO RELATED APPLICATIONS

This application claims the priority of Korean Patent Application No. 10-2011-0139994 filed on Dec. 22, 2011, in the Korean Intellectual Property Office, the disclosure of which is incorporated herein by reference.

### BACKGROUND OF THE INVENTION

1. Field of the Invention

The present invention relates to a base assembly for a motor and a hard disk drive including the same, and more particularly, to a base assembly for a motor and a hard disk drive including the same that are improved in a coupling structure of a magnet providing a driving force to a base and a magnetic head.

2. Description of the Related Art

A hard disk drive (HDD), a computer information storage device, reads data stored on a disk or writes data to the disk using a magnetic head.

In this hard disk drive, abase is installed with a head driver, that is, a head stack assembly (HSA), capable of altering a position of the magnetic head relative to the disk. The magnetic head performs its function while moving to a desired position in a state in which it is suspended at a predetermined height above a writing surface of the disk by the head driver.

Further, the head stack assembly uses a voice coil motor (VCM) generating driving force for the magnetic head. The voice coil motor (VCM) generates driving force by electromagnetic interaction between a coil and magnets located on upper and lower portions of the coil.

Here, the magnets are provided with yokes so as to improve coupling with the base and magnetic flux density, and the yokes need to be firmly fixed to the base for the reason of prevention of separation, or the like, due to strong pulling force between the magnets, external impacts, or the like.

Meanwhile, according to the related art, the base coupled to the yokes fixing the magnets has been manufactured by a post-processing scheme of die-casting aluminum (Al) and then removing burrs or the like, generated due to the die-casting.

However, the die-casting method according to the related art uses a process of injecting aluminum (Al) in a melting state to require high temperature and high pressure, which leads to a considerable amount of energy consumption and an increase in process time.

Therefore, in order to solve defects in the die-casting process, the base is manufactured by press processing. However, in the case of press processing, the weight of the base maybe increased due to the yoke in terms of material characteristics.

Therefore, when the magnets provided in the voice coil motor are coupled to the base manufactured by press processing, research into a technology of increasing a coupling force to prevent the magnets from being separated due to external impacts or the like, while minimizing an increase in weight without affecting magnetism of the magnets, has been urgently demanded.

In the following Related Art Documents 1 and 2, magnets are still likely to be separated from a base due to external impacts or the like.

### RELATED ART DOCUMENT

(Patent Document 1) Japanese Patent Laid-Open Publication No. 2003-272323

(Patent Document 2) Japanese Patent Laid-Open Publication No. 2003-232321

### SUMMARY OF THE INVENTION

An aspect of the present invention provides a base assembly for a base and a hard disk drive including the same capable of minimizing an increase in weight while increasing a coupling force without affecting magnetism of magnets when magnets of a voice coil motor (VCM) are fixed to a base.

According to an aspect of the present invention, there is provided a base assembly for a motor, including: a base for a motor; a magnet mounted in the base to provide a driving force to a magnetic head; and a magnet insertion part having the magnet inserted therein and formed to penetrate through the base so as to restrict a movement of the magnet.

The magnet insertion part may be formed to correspond to the magnet.

The magnet insertion part may be formed by a side wall protruding in an upward axial direction.

The magnet insertion part may be formed by a side wall including a protruding part protruding in an upward axial direction and a support part extending toward a center of the magnet from the protruding part.

The base assembly may further include a yoke coupled to the magnet to seal the magnet insertion part, and the yoke may be coupled to the protruding part and the support part.

The base assembly may further include a yoke coupled to the magnet and a side wall of the magnet insertion part to seal the magnet insertion part.

The yoke and a bottom surface of the base may be disposed on the same plane.

The yoke and the side wall of the magnet insertion part may be coupled to each other by at least one of welding, bonding using an adhesive, and press-fitting.

The base may be formed by press processing.

The magnet may be press-fitted in the magnet insertion part.

According to another aspect of the present invention, there is provided a hard disk drive, including: abase assembly for a motor as described above; a spindle motor coupled to the base to rotate a disk; and a head stack assembly (HSA) moving a magnetic head to a predetermined position on the disk to thereby write data to the disk and read data from the disk.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view schematically showing a hard disk drive including abase assembly for a motor according to an embodiment of the present invention;

FIG. 2 is a perspective view schematically showing a base assembly for a motor according to an embodiment of the present invention;

FIG. 3 is an enlarged cross-sectional view taken along line A-A of FIG. 2;

FIG. 4 is a perspective view schematically showing a process of forming a magnet insertion part in a base provided in a base assembly for a motor according to an embodiment of the present invention;

FIG. 5 is an exploded perspective view schematically showing a process of coupling magnets and yokes in the magnet insertion part of the base subjected to the process of FIG. 4;

FIG. 6 is an exploded perspective view schematically showing a base assembly for a motor according to another embodiment of the present invention;

FIG. 7 is a perspective view schematically showing a base assembly for a motor according to another embodiment of the present invention; and

FIG. 8 is an enlarged cross-sectional view taken along line B-B of FIG. 7.

### DETAILED DESCRIPTION OF THE INVENTION

Embodiments of the present invention will now be described in detail with reference to the accompanying drawings.

However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, like reference numerals will be used to designate like components having similar functions throughout the drawings within the scope of the present invention.

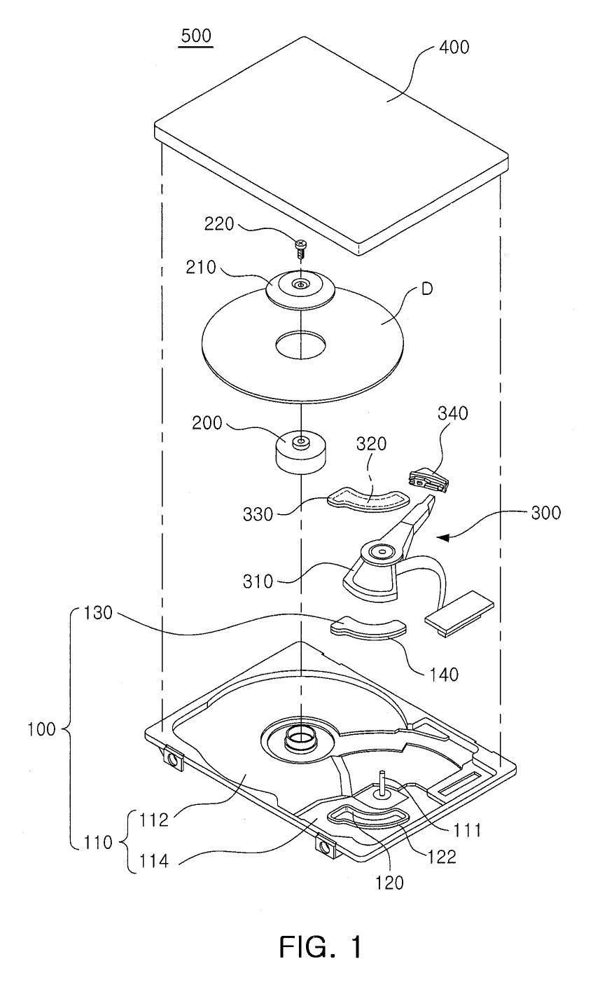

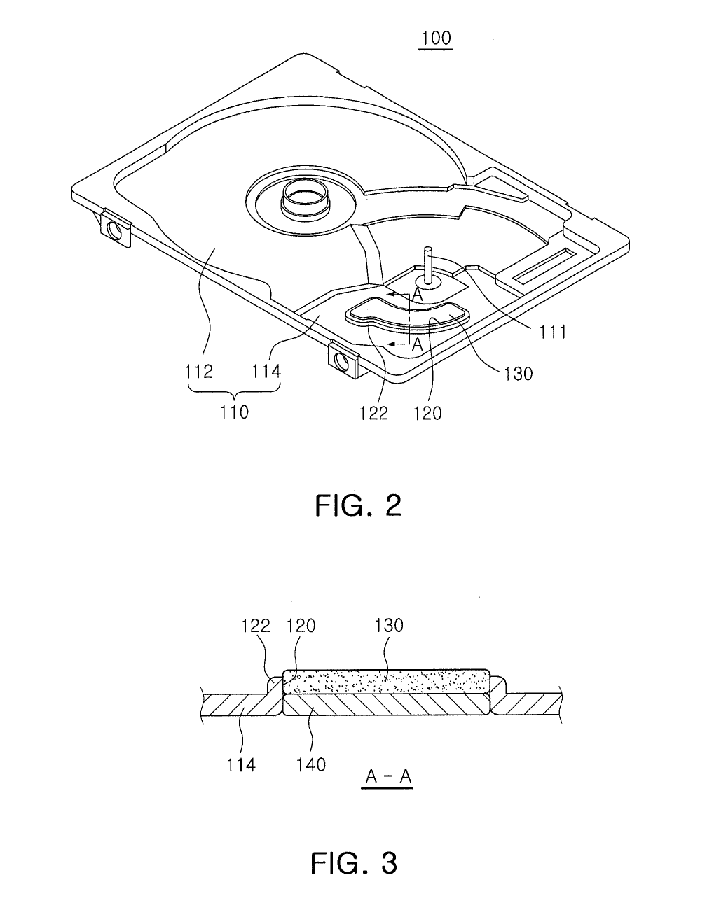

FIG. 1 is an exploded perspective view schematically showing a hard disk drive including a base assembly for a motor according to an embodiment of the present invention, FIG. 2 is a perspective view schematically showing the base assembly for a motor according to the embodiment of the present invention, and FIG. 3 is an enlarged cross-sectional view taken along line A-A of FIG. 2.

Referring to FIGS. 1 to 3, a hard disk drive 500 including a base assembly for a motor (hereinafter, referred to as a base assembly) according to an embodiment of the present invention may include a base assembly 100 including a base 110, a spindle motor 200 rotating a disk D, and a head stack assembly (HAS) 300.

First, terms with respect to directions will be defined. As shown in FIG. 1, an upward axial direction or a downward axial direction refers to a direction toward a top surface of the base 110 from a bottom surface of the base 110 for a motor (hereinafter, referred to as a base) or vice versa.

The base assembly 100 may include the base 110 including a magnet insertion part 120 and a magnet 130 provided in a voice coil motor (VCM).

In the hard disk drive 500 according to the present embodiment of the invention, the base 110 may be a housing forming an exterior together with a cover 400.

Here, the base 110 may be manufactured by forming a basic shape by a pressing process and then forming a final shape by an additional bending or cutting process.

That is, unlike the related art base manufactured in a post-processing scheme in which aluminum (Al) is die-cast and burrs or the like generated due to the die-casting process are then removed, the base 220 according to the embodiment of the invention may be manufactured by performing a single process such as press processing or another process on a cold rolled steel sheet (SPCC, SPCE, or the like), a hot rolled steel sheet, a stainless steel, a lightweight alloy steel sheet such as boron or magnesium alloy, or the like.

Therefore, the base 110 according to the embodiment of the present invention may be manufactured by press processing to minimize processing time and energy consumption, thereby improving productivity.

Here, the base 110 may provide an internal space, and the spindle motor 200 and the head stack assembly (HSA) 300 may be mounted in the internal space.

Meanwhile, the base 110 manufactured by pressing process may include a disk mounting part 112 and a magnet mounting part 114.

The disk mounting part 112, in which the disk D coupled to the spindle motor 200 is mounted, may be formed to have a circular shape corresponding to the shape of the disk D.

In detail, the disk mounting part 112 may be formed by allowing a portion of the base 110 to be protruded in the downward axial direction such that the disk D is accommodated therein.

Here, the magnet mounting part 114, in which the magnet 130 of the VCM forming the head stack assembly (HSA) 300 is mounted, may include the magnet insertion part 120 for restricting a movement of the magnet 130.

Here, the magnet 130 may provide a driving force to a magnetic head by electromagnetic interaction with a coil 310 of the VCM, and may be firmly fixed to the base 110 via a yoke 140.

In detail, the magnet 130 may be a lower magnet 130 mounted under the coil 310, and the yoke 140 may be a lower yoke 140 coupled to the lower magnet 130.

Meanwhile, the magnet insertion part 120 may be formed to penetrate through the base 110 such that the magnet 130 is inserted therein, thereby restricting the movement of the magnet 130.

In addition, the magnet insertion part 120 may be formed to correspond to the magnet 130 and a side wall 122 of the magnet insertion part 120 may be protruded in the upward axial direction.

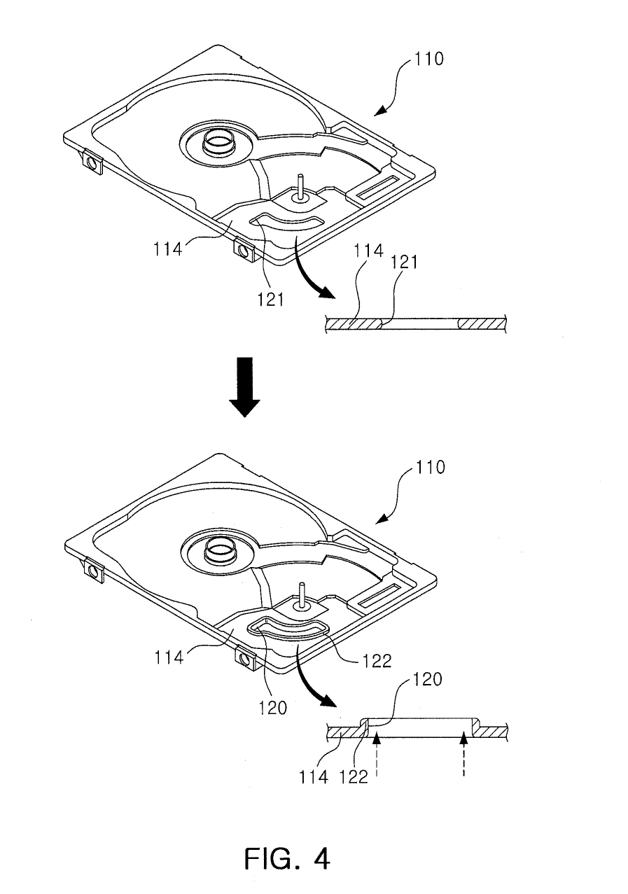

That is, in order to form the magnet insertion part 120 by the side wall 122 protruding in the upward axial direction, the magnet mounting part 114 of the base 110 may be formed as a hole 121 having a predetermined size (see FIG. 4) by extracting a predetermined region of the base 110.

Thereafter, the upwardly protruding side wall 122 may be formed by pressing a peripheral portion of the hole 121 in the upward axial direction.

Therefore, the base 110 may include the magnet insertion part 120 by the above-mentioned process, and the magnet 130 may be fixed to the base 110 by inserting the yoke 140 coupled to the magnet 130 in the upward or downward axial direction of the magnet insertion part 120.

Here, the magnet 130 is magnetized in a state in which the magnet 130 is coupled to the yoke 140 before being fixed to the magnet insertion part 120, thereby minimizing magnetic leakage when being magnetized. A description thereof will be provided below.

Meanwhile, the yoke 140 is combined with the magnet 130 and the side wall 122 of the magnet insertion part 120 to seal the magnet insertion part 120, and the yoke 140 and the bottom surface of the base 110 may be disposed on the same plane.

In addition, the yoke 140 and the side wall 122 of the magnet insertion part 120 may be coupled to each other by at least one of welding, bonding using an adhesive, and press-fitting.

In addition, the magnet 130 may be fixed to the magnet insertion part 120 by press-fitting.

The base assembly 100 according to the embodiment of the present invention may minimize an increase in a total weight of the base assembly 100 due to the magnet insertion part 120.

That is, even in the case that the magnet insertion unit 120 is formed in the base 110 and the yoke 140 coupled to the magnet 130 is inserted in the magnet insertion unit 120, the increase in the total weight of the base assembly 100 can be minimized.

In other words, the base 110 according to the embodiment of the present invention is manufactured by performing press processing on a steel plate having magnetism as described above, which results in a slight increase in the weight of the base, as compared with the related art base manufactured by die-casting aluminum (Al), due to the characteristics of the steel plate.

Therefore, when the yoke coupled to the magnet is simply combined with the base manufactured by the press processing, the weight of the base may be increased.

However, the base 110 according to the embodiment of the present invention is prevented from having an increase in the total weight thereof due to the magnet insertion part 120 formed by penetrating through a predetermined region thereof.

Further, the base manufactured by pressing the steel plate has magnetism, and accordingly, it may be directly coupled by using the magnetism of the magnet without a yoke.

However, in the case of coupling the magnetized magnet, it is difficult to fix the magnet at an accurate position due to magnetic force. When being magnetized after coupling by bonding using an adhesive, degradation in the performance of the magnet may be caused by magnetic leakage due to the magnetism of the base.

However, in the base assembly 100 according to the embodiment of the present invention, the magnet 130 is inserted into the magnet insertion part 120 in a state in which the magnet 130 is magnetized after being coupled to the yoke 140, such that magnetic leakage problem caused by the base 110 may not occur. Therefore, degradation in the performance of the VCM due to the magnetic leakage of the magnet 130 may be prevented.

Further, the magnet 130 may be simply and firmly fixed to the accurate position of the base 110 due to the magnet insertion part 120 and the movement of the magnet 130 may be restricted by the magnet insertion part 120, such that the separation of the magnet 130 from the base 110 due to external impacts or the like, can be minimized.

The spindle motor 200, which is provided to rotate the disk D, is fixedly installed in a center of the disk mounting part 112. The disk D is coupled to the spindle motor 200 such that it rotates together with the spindle motor 200. The disk D may have a writing surface on which data is written.

Here, a clamp 210 may be coupled to an upper end portion of the spindle motor 200 by a screw 220 in order to firmly fix the disk D to the spindle motor 200.

In addition, although FIG. 1 shows a case in which a single disk D is mounted on the spindle motor 200, the present invention is not limited thereto. That is, one or more disks D may be mounted on the spindle motor 200. In the case in which a plurality of disks D are mounted on the spindle motor 200, a ring-shaped spacer may be disposed between the plurality of disks D in order to maintain an interval therebetween.

The head stack assembly (HSA) 300 may have a magnetic head mounted thereon and move the magnetic head to a predetermined position to thereby write data to the disk D or read data written on the disk D.

In addition, the head stack assembly (HSA) 300 may move the magnetic head to a predetermined position of the disk D by the VCM including the coil 310 and the upper and lower magnets 320 and 130.

The VCM may be controlled by a servo control system and may include the upper and lower magnets 320 and 130 disposed above and under the coil 310, and the upper and lower magnets 320 and 130 may be coupled to the upper and lower yokes 330 and 140, respectively, in order to increase magnetic flux density and be fixed to the base 110.

As described above, the lower magnet 130 and the lower yoke 140 may be coupled to the magnet insertion part 120 formed on the magnet mounting part 114 of the base 110 to thereby be fixed to the base 110.

Meanwhile, the magnetic head may rotate around the pivot shaft 111 according to the Fleming's left hand rule by the interaction between current input by the coil 310 of the VCM and magnetic field formed by the upper and lower magnets 320 and 130.

Therefore, the head stack assembly (HSA) 300 may rotate at a predetermined angle based on the pivot shaft 111 by the VCM.

Meanwhile, when an operation start command is input to the hard disk drive 500 according to the embodiment of the present invention and the disk D starts to rotate, the VCM rotates a swing arm in a counterclockwise direction to thereby move the magnetic head onto the writing surface of the disk D.

On the other hand, when an operation stop command is input to the hard disk drive 500 according to the embodiment of the present invention, the VCM rotates the swing arm in a clockwise direction to thereby allow the magnetic head to deviate from the disk D.

The magnetic head deviating from the writing surface of the disk D is parked on a ramp 340 provided outside the disk D.

Here, the ramp 340 may allow the magnetic head to be spaced apart from the disk D by a predetermined interval in the case in which the magnetic head moves to the disk D, while simultaneously parking the magnetic head, whereby the data of the disk D may be stably read.

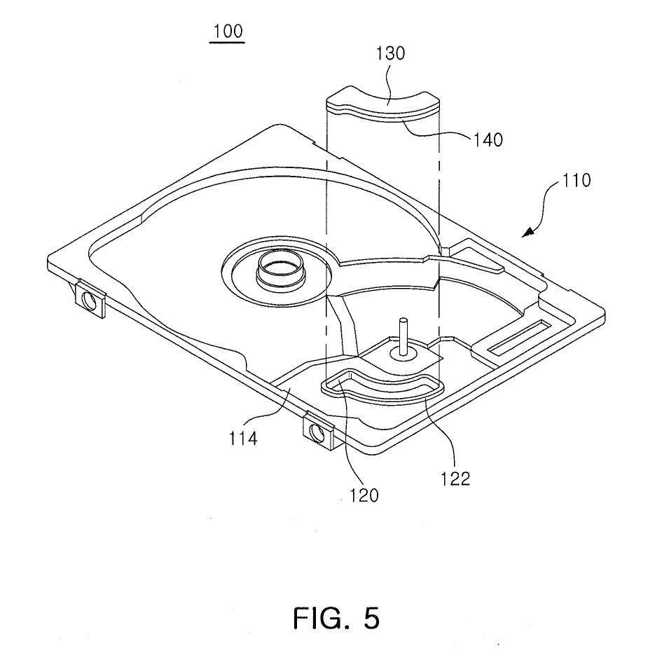

FIG. 4 is a perspective view schematically showing a process of forming a magnet insertion part in a base provided in a base assembly for a motor according to an embodiment of the present invention, and FIG. 5 is an exploded perspective view schematically showing a process of coupling magnets and yokes in the magnet insertion part of the base subjected to the process of FIG. 4.

Referring to FIGS. 4 and 5, the base assembly 100 for a motor according to this embodiment of the invention may form the hole 121 of a predetermined size by extracting a predetermined region of the magnet mounting part 114 in order to form the magnet insertion part 120.

Thereafter, the upwardly protruding side wall 122 may be formed by pressing (arrow) the peripheral part of the hole 121 in the upward axial direction and a height thereof may be changed in consideration of the thickness of the magnet 130 and the yoke 140.

After forming the magnet insertion part 120 including the side wall 122 protruding in the upward axial direction, the magnet 130 coupled to the yoke 140 may be magnetized and the yoke 140 maybe inserted into the magnet insertion part 120 in the upward or downward axial direction of the magnet insertion part 120.

In addition, the yoke 140 and the side wall 122 of the magnet insertion part 120 may be finally coupled to each other by at least one of welding, bonding using an adhesive, and press-fitting.

Meanwhile, the magnet 130 may be press-fitted into the side wall 122 of the magnet insertion part 120.

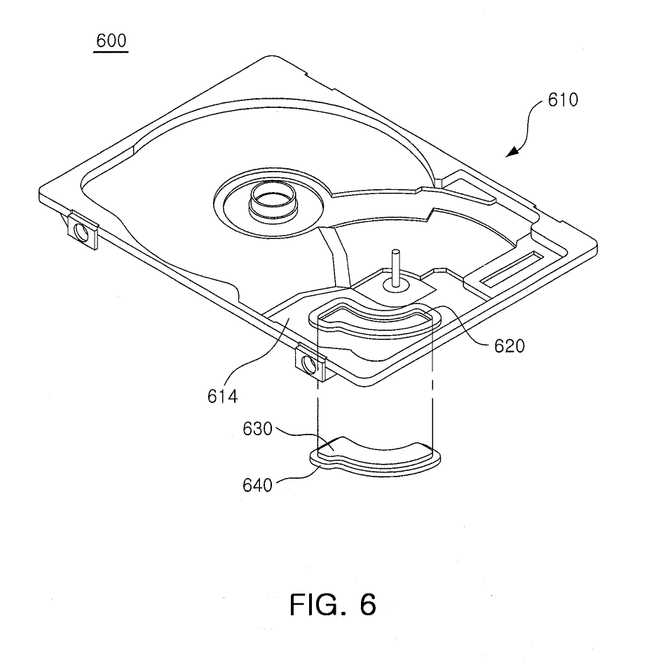

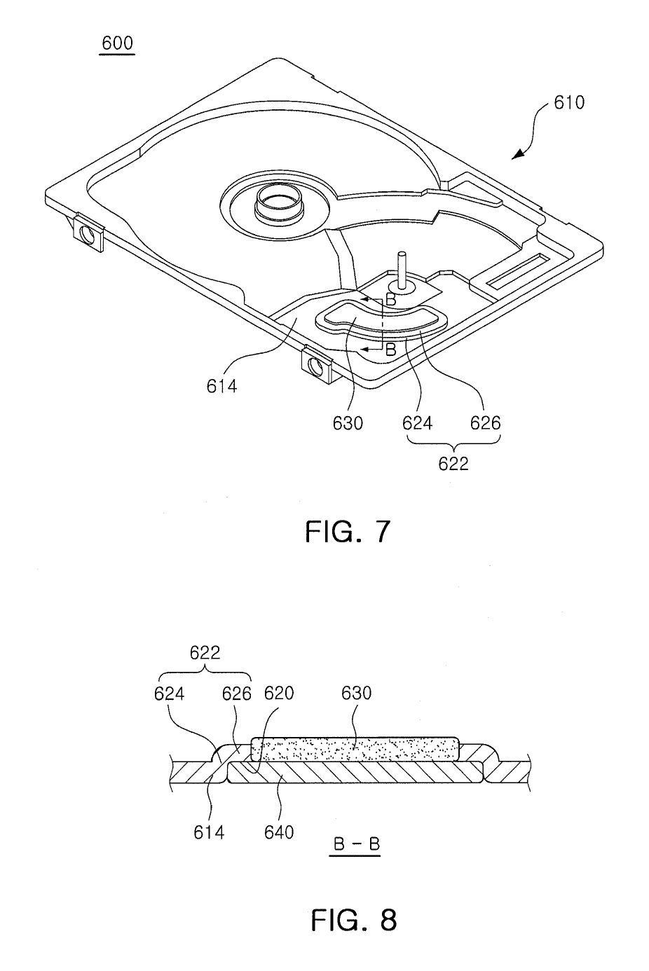

FIG. 6 is an exploded perspective view schematically showing a base assembly for a motor according to another embodiment of the present invention, FIG. 7 is a perspective view schematically showing a base assembly for a motor according to another embodiment of the present invention, and FIG. 8 is an enlarged cross-sectional view taken along line B-B of FIG. 7.

Referring to FIGS. 6 through 8, a base 610 provided in abase assembly 600 for a motor according to another embodiment of the present invention may include a magnet insertion part 620, and the magnet insertion pat 620 may include a protruding part 624 and a support part 626.

Here, the protruding pat 624 and the support part 626 may form a side wall 622 of the magnet insertion part 620, and the support part 626 may extend toward the center of a magnet 630 from the protruding part 624.

In other words, in order to form the protruding part 624 and the support part 626, may form a hole may be formed in the base 610 by extracting a predetermined region of a magnet mounting part 614 and a peripheral part of the hole may be pressed.

In this case, the protruding part 624 and the support part 626 may be formed by a single pressing process.

Alternatively, the protruding part 624 may be primarily formed and then, the support part 626 may be secondarily formed.

When the magnet insertion part 620 including the protruding part 624 and the support part 626 is formed in the base 610 by the aforementioned process, a yoke 640 coupled to the magnet 630 maybe inserted in the downward axial direction of the magnet insertion part 620.

Here, the yoke 640 maybe slightly larger than the magnet 630. After the yoke 640 and the magnet 630 are coupled to each other, a portion of the yoke 640 protruded outwardly of the magnet 630 maybe seated on a bottom surface of the support part 626.

Meanwhile, the magnet 630 is coupled to the yoke 640 and the magnet 630 may be magnetized before being fixed to the magnet insertion part 620, thereby previously preventing magnetic leakage caused by the base 610 at the time of being magnetized.

Here, the yoke 640, the protruding part 624 and the support part 626 may be coupled to each other by at least one of welding, bonding using an adhesive, and press-fitting.

In addition, the magnet 630 may be press-fitted in the support part 626.

As set forth above, in a base assembly for a motor and a hard disk drive including the same according to embodiments of the present invention, magnets of a VCM may be firmly coupled to a base in a simplified manner.

Further, magnetic leakage of the magnets of the VCM may be minimized to thereby prevent degradation in the performance of the VCM.

In addition, even in a case in which the magnets of the VCM are coupled to the base, an increase in weight of the base may be minimized.

While the present invention has been shown and described in connection with the exemplary embodiments, it will be apparent to those skilled in the art that modifications and variations can be made without departing from the spirit and scope of the invention as defined by the appended claims.

What is claimed is:

1. A base assembly for a motor, comprising:
a base for a motor;
a magnet mounted in the base to provide a driving force to a magnetic head; and
a magnet insertion part having the magnet inserted therein and formed to penetrate through the base so as to restrict a movement of the magnet.

2. The base assembly of claim 1, wherein the magnet insertion part is formed to correspond to the magnet.

3. The base assembly of claim 1, wherein the magnet insertion part is formed by a side wall protruding in an upward axial direction.

4. The base assembly of claim 1, wherein the magnet insertion part is formed by a side wall including a protruding part protruding in an upward axial direction and a support part extending toward a center of the magnet from the protruding part.

5. The base assembly of claim 4, further comprising a yoke coupled to the magnet to seal the magnet insertion part,
wherein the yoke is coupled to the protruding part and the support part.

6. The base assembly of claim 1, further comprising a yoke coupled to the magnet and a side wall of the magnet insertion part to seal the magnet insertion part.

7. The base assembly of claim 5, wherein the yoke and a bottom surface of the base are disposed on the same plane.

8. The base assembly of claim 5, wherein the yoke and the side wall of the magnet insertion part are coupled to each other by at least one of welding, bonding using an adhesive, and press-fitting.

9. The base assembly of claim 1, wherein the base is formed by press processing.

10. The base assembly of claim 1, wherein the magnet is press-fitted in the magnet insertion part.

11. A hard disk drive, comprising:
the base assembly for a motor of claim 1;
a spindle motor coupled to the base to rotate a disk; and
a head stack assembly (HSA) moving a magnetic head to a predetermined position on the disk to thereby write data to the disk and read data from the disk.
